(19) United States
(12) Patent Application Publication
(10) Pub. No.: US 2007/0274293 A1
(43) Pub. Date: Nov. 29, 2007

(54) Archiving VoIP conversations

(75) Inventor: Scott C. Forbes, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/441,519

(22) Filed: May 26, 2006

(51) Int. Cl. H04L 12/66

(52) U.S. Cl. 370/352; 370/401

(57) ABSTRACT

Generally described, the present invention is directed to a method and system that provides the ability to record and store a digital conversation exchanged among mutually agreed parties in a specified archive database. In some instances, content of a digital conversations may be stored (e.g., for legal and/or medical purposes) along with the authenticity of those conversations. Parties who are involved in the digital conversation can authenticate and associate themselves with the conversation. The authentication may be integrated or bound with the digital conversation so that the digital conversation can be stored with a proof of authenticity in the specified archive database. The stored conversation may be retrieved by the parties or any entity with a delegation from the party for reviewing the conversation, or incorporating new information into the stored conversation.

### BACKGROUND

Generally described, an Internet telephony system provides an opportunity for users to have a call connection with enhanced calling features compared to a conventional Public Switched Telephone Network (PSTN) based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services. However, current VoIP approaches do not provide the ability for individuals to generate a record of an important conversation along with associated authenticity information, such as digital signatures of the individuals.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with at least one aspect of the present invention, a method for storing a portion of a conversation to a designated database is provided. The method includes receiving a request to store a part of the conversation and generating a record of the part of the conversation with corresponding authentication information and conversation data packets. The record of the part of the conversation may be reused at anytime after the conversation to ensure the content of the conversation or the authenticity of parties who have participated in the conversation. A set of contextual data packets, voice data packets, and/or media data packets may be collected from the conversation to generate such record. In addition, authentication information (for example, validated digital signature and/or biometric information of the parties) may be bonded with the collected set of data packets. The generated record of the part of the conversation may be stored in the designated database.

In accordance with another aspect of the present invention, a computer-readable medium having computer-executable components for archiving digital voice conversations is provided. The computer-readable medium includes an archiving request component, an information collection component, and an authentication application component. The archiving request component is configured to generate archive requests to record (store) a conversation. The information collection component collects authentication information from at least one contact point involved in a digital voice conversation. The authentication application component applies the collected authentication information to the conversation associated with the request to authenticate at least one contact point. The collected authentication information may be used to validate contact points to ensure that they are appropriate for the conversation and/or for verifying the integrity of the recorded conversation. In one example, applying the collected authentication information includes binding the authentication (validation) with data packets of the conversation.

In accordance with yet another aspect of the present invention, a method for generating an authenticated conversation is provided. The method includes receiving authentication information from at least one contact point involved in a digital voice conversation, collecting a plurality of data packets from the digital voice conversation, and binding the received authentication information with the plurality of data packets to generate an authenticated conversation. The authenticated conversation will eventually be stored in an archiving database for future use.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for providing establishing a conversation channel between various clients in accordance with an aspect of the present invention;

FIG. 2 is a block diagram illustrative of various VoIP devices corresponding to a VoIP client in accordance with an aspect of the present invention;

FIG. 3 is a block diagram illustrative of various components associated with a VoIP client device in accordance with an aspect of the present invention;

FIGS. 4A and 4B are block diagrams illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIG. 7A-7D are block diagrams illustrating interactions among various VoIP entities for collecting and transferring contextual information in accordance with an aspect of the present invention;

FIG. 8A is a block diagram illustrative of various attributes and classes of structural hierarchies corresponding to VoIP contextual information in accordance with an aspect of the present invention;

FIG. 8B is a block diagram of a call basic class which is an exemplary subset of the structural hierarchies illustrated in FIG. 8A;

FIG. 8C is a block diagram of a call context class which is an exemplary subset of the structural hierarchies illustrated in FIG. 8A;

FIG. 8D is a block diagram of a device type class which is an exemplary subset of the structural hierarchies illustrated in FIG. 8A;

FIG. 8E is a block diagram of a VoIP clients class which is an exemplary subset of the structural hierarchies illustrated in FIG. 8A;

FIG. 9 is a flow diagram of a conservation achieving routine in accordance with an aspect of the present invention; and

FIG. 10 is a flow diagram of an authentication application routine in accordance with an aspect of the present invention.

### DETAILED DESCRIPTION

While illustrative embodiments have been illustrated and described, it will be appreciated that various changes can be made therein without departing from the spirit and scope of the invention.

Generally described, the present invention relates to a method and system that provides the ability to record and store a digital conversation exchanged among mutually agreed parties. More specifically, in some instances, digital conversations may be stored (e.g., for legal and/or medical purposes) along with the authenticity of those digital conversations. Embodiments of the present invention provide the ability for the parties involved in the digital conversation to authenticate and associate themselves with the conversation. The authentication may be integrated or bound with the digital conversation so that the digital conversation can be stored with a proof of authenticity in an archive database.

Authentication information may be exchanged as part of contextual information represented in accordance with “structured hierarchies.” “Structured hierarchies,” as used herein, are predefined organizational structures for arranging contextual information to be exchanged between two or more VoIP devices. For example, structured hierarchies may be XML namespaces. Further, a VoIP conversation includes one or more data streams of information related to a conversation, such as contextual information and voice/multimedia information, exchanged over a conversation channel. Although the present invention will be described with relation to illustrative structured hierarchies and an IP telephony environment with an emphasis on voice communication, one skilled in the relevant art will appreciate that the disclosed embodiments are illustrative in nature and should not be construed as limiting.

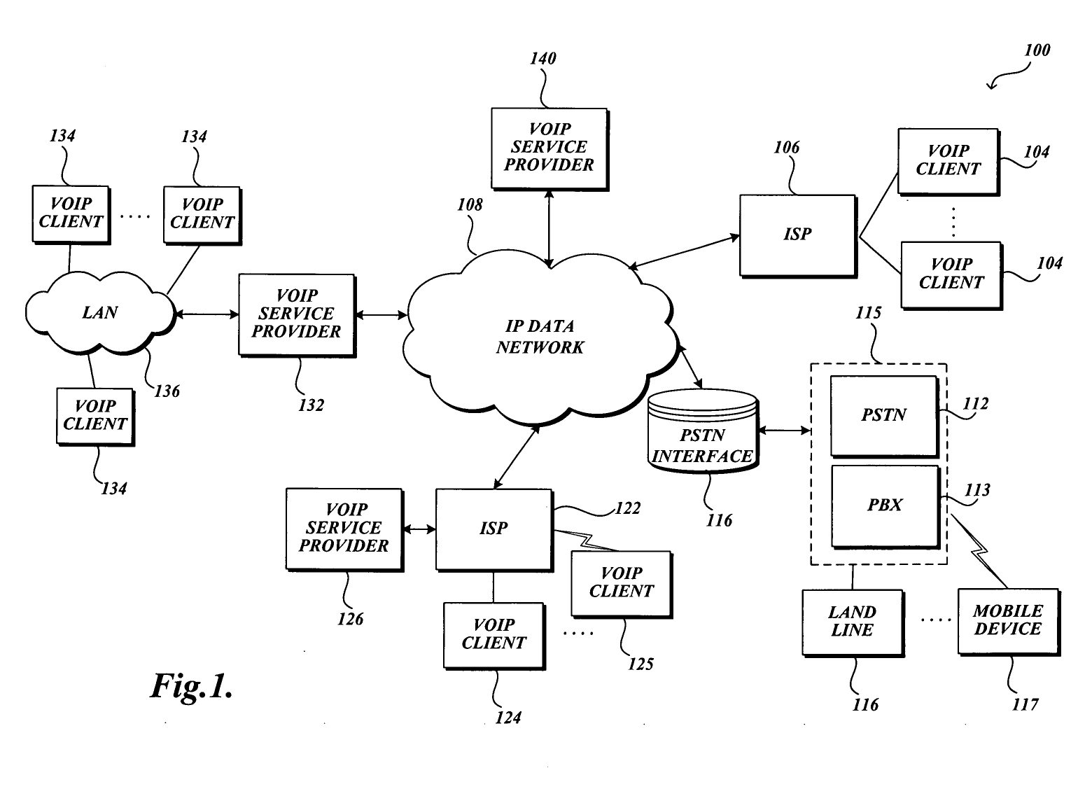

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices and a unique VoIP client identifier. For example, a single individual, five associated VoIP devices, and a unique VoIP client identifier may collectively makeup a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live where each individual is associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN) and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation. VoIP clients 104, 124, 125, 136 may create, maintain, and provide information relating to predetermined priorities for incoming calls. In addition, the VoIP service providers 126, 132, 140 may also generate, maintain, and provide a separated set of metadata information (e.g., provider priority list) for individuals communicating in a call conversation.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 via PSTN 112, or Private Branch exchange (PBX) 113. A PSTN interface 114 such as a PSTN gateway may provide access between POTS/PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices such as land line 116 may request a connection with the VoIP client and an appropriate VoIP device associated with the VoIP client will be selected to establish a call connection with the conventional voice devices. In one example, an individual associated with the VoIP client may specify which devices are to be used in connecting a call based on a variety of conditions (e.g., connection based on the calling party, the time of day, etc.).

It is understood that the above mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

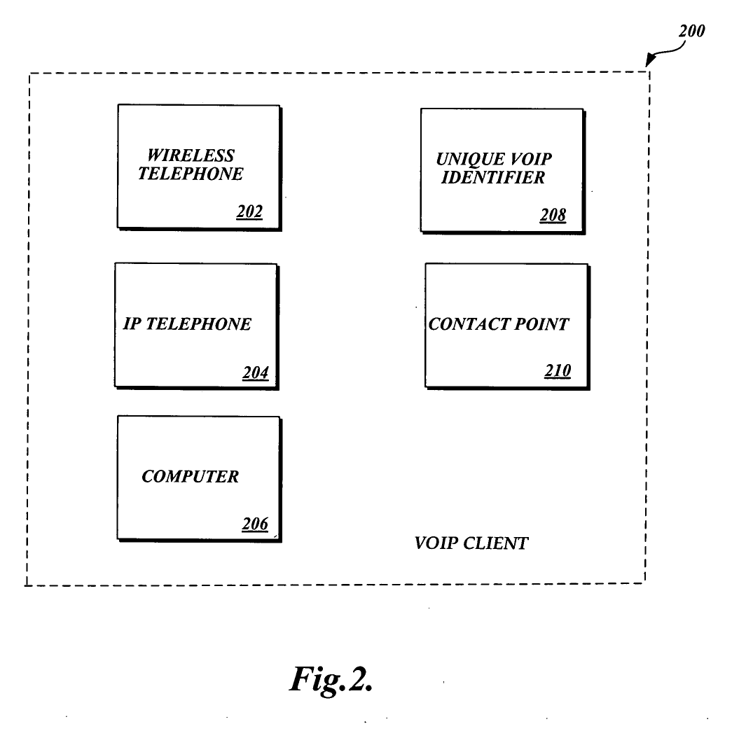

Referring now to FIG. 2, a block diagram illustrating an exemplary VoIP client 200 that includes several VoIP devices and a unique client identifier, in accordance with an embodiment of the present invention, is shown. Each VoIP device 202, 204, 206 may include a storage that is used to maintain voice messages, address books, client specified rules, priority information related to incoming calls, etc. Alternatively, or in addition thereto, a separate storage maintained, for example, by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique client identifier 208. The unique client identifier(s) 208 may be constant or change over time. For example, the unique identifier(s) 208 may change with each call. The unique client identifier is used to identify the client and to connect with the contact point 210 associated with the VoIP client. The unique client identifier may be maintained on each VoIP device included in the VoIP client and/or maintained by a service provider that includes an association with each VoIP device included in the VoIP client. In the instance in which the unique client identifier is maintained by a service provider, the service provider may include information about each associated VoIP device and knowledge as to which device(s) to connect for incoming communications. In an alternative embodiment, the VoIP client 200 may maintain multiple client identifiers. In this embodiment, a unique client identifier may be temporarily assigned to the VoIP client 200 for each call session.

The unique client identifier may be used similarly to a telephone number in PSTN. However, instead of dialing a typical telephone number to ring a specific PSTN device such as a home phone, the unique client identifier is used to reach a contact point such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

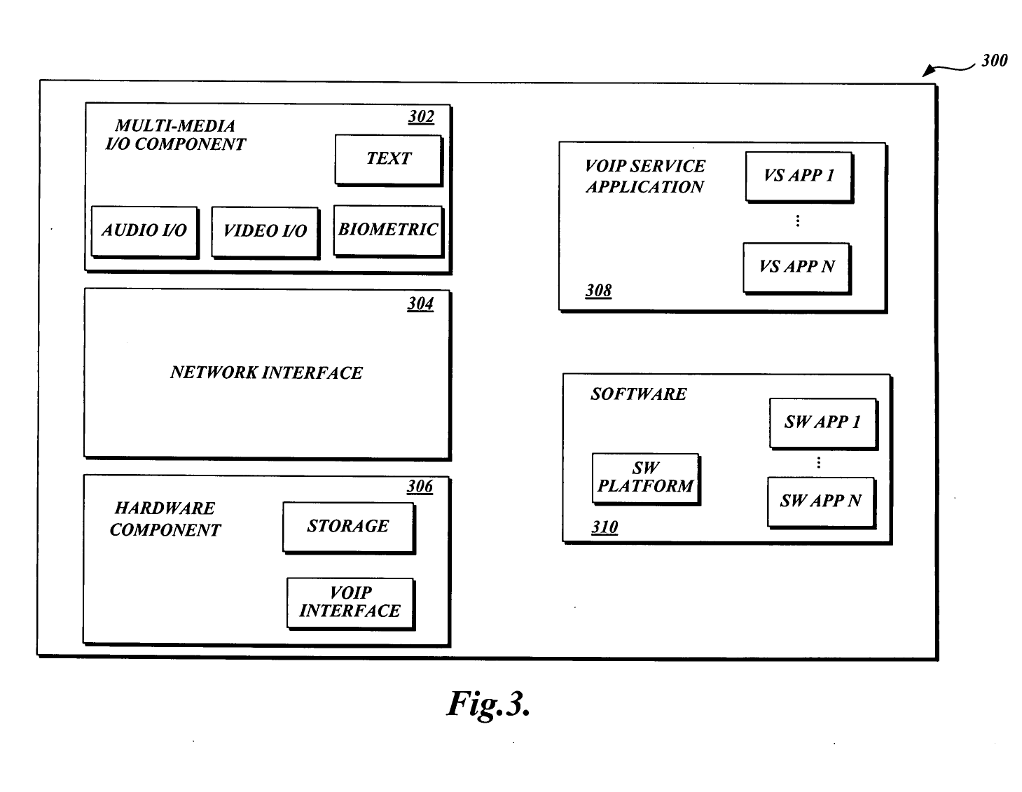

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles) associated with the VoIP client in which the device is included. In one embodiment, the hardware component 306 may include a VoIP interface card which allows non-VoIP client device to transmit and receive a VoIP conversation.

The device 300 may further include a software application component 310 for the operation of the device 300 and a VoIP Service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services. The CODEC may use voice profiles to filter and improve incoming audio.

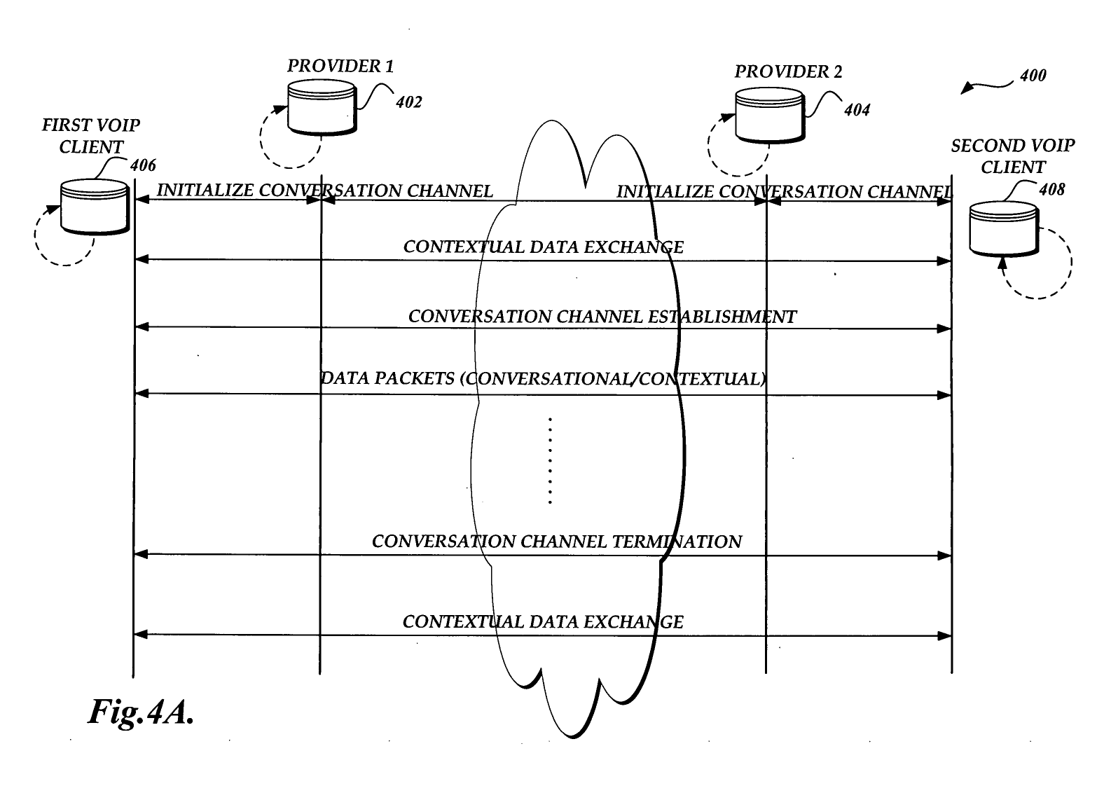

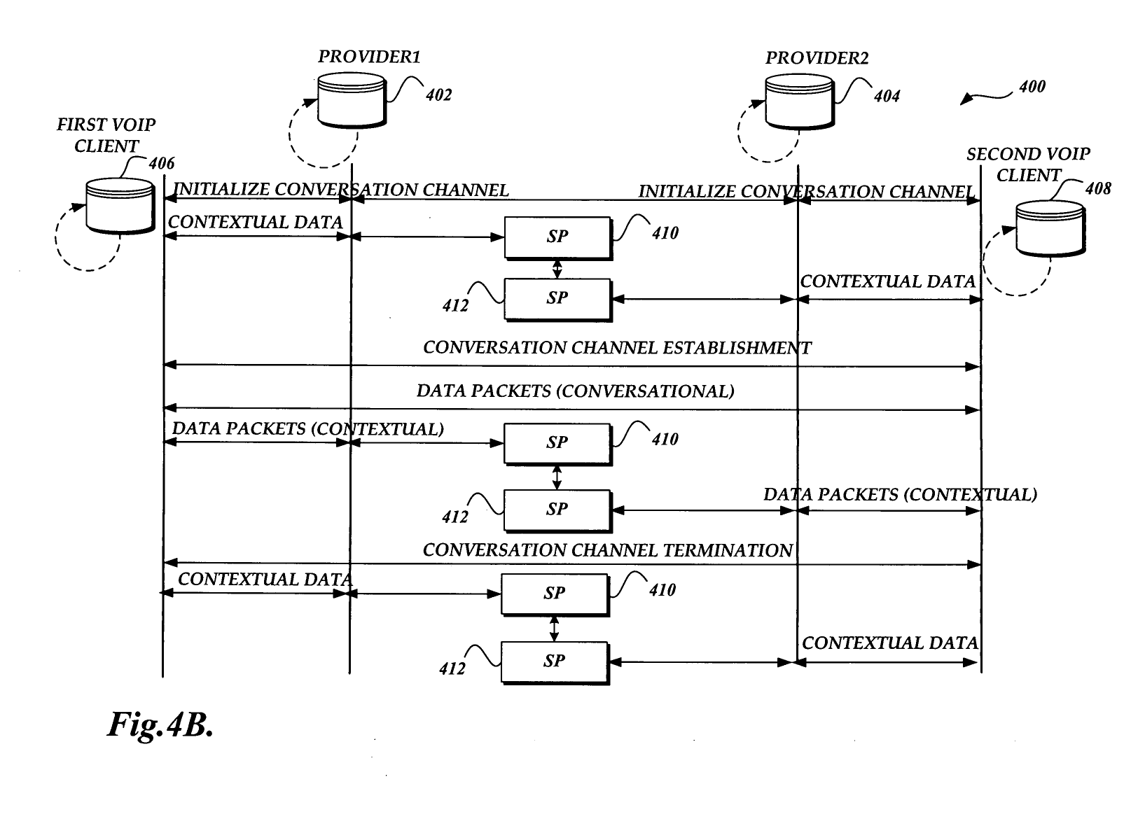

With reference to FIG. 4A, a block diagram illustrative of a conversation flow 400 between VoIP devices of two different VoIP clients over a conversation channel, in accordance with an embodiment of the present invention, is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over a Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, we will utilize the example in which both the first VoIP client 406 and the second VoIP client 408 each only includes one VoIP device. Accordingly, the discussion provided herein will refer to connection of the two VoIP devices. The individual using the device of the first VoIP client 406 may select or enter the unique client identifier of the client that is to be called. Provider 1 402 receives the request from the device of the first VoIP client 408 and determines a terminating service provider (e.g., Provider 2 404 of the second VoIP client 408) based on the unique client identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. For example, the contextual information sent from the called VoIP client 406 may include a priority list of incoming calls from various potential calling VoIP clients including VoIP client 406.

Available media types, rules of the calling client and the client being called, and the like, may also be part of the contextual information that is exchanged during the connection set-up phase. The contextual information may be processed and collected by one the devices of the first VoIP client 406, one of the devices of the second VoIP client 408, and/or by VoIP service providers (e.g., Provider 1 402 and Provider 2 404), depending on the nature of the contextual information. In one embodiment, the VoIP service providers 402, 404 may add/delete some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail, the data packets, including conversation data packets and contextual data packets, are communicated over the established conversation channel between the connected devices.

Conversation data packets carry data related to a conversation, for example, a voice data packet or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

FIG. 4B is a block diagram illustrative of a conversation flow 400 between devices of two VoIP clients via several service providers in accordance with an embodiment of the present invention. As with FIG. 4A, the example described herein will utilize the scenario in which each client only has one device associated therewith and the connection occurs between those two devices. During a connection set-up phase, a device of a first VoIP client 406 requests to initiate a conversation channel for communication with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 408.

Before the device of the first VoIP client 406 and the device of the second VoIP client 408 begin to exchange voice data packets, contextual information may be exchanged between the first VoIP client 406 and the second VoIP client 408. Contextual information may be exchanged using a structured organization defined by the first VoIP client 406. In one embodiment, Provider 1 402 may identify particular contextual information which Provider 1 402 desires to obtain from the first VoIP client 406. The first VoIP client 406 may specify the corresponding structure based on the content of the contextual information. The identification of the structure for exchanging information and additional contextual information may be transmitted to the second VoIP client 408 via Provider 2 404 and Provider 1 402.

The contextual information may be processed and collected at a device of the first VoIP client, a device of the second VoIP client, the VoIP service providers (e.g., Provider 1 and Provider 2), or a third-party service, depending on the nature of the contextual information. For example, authentication of the contact points using the client devices may be collected by the service providers 402, 404 and only temporarily provided to the devices. Authentication of a contact point may be obtained in a variety of ways. For example, a contact point may be authenticated using voice recognition, biometrics, passwords, smartcard, etc. Any type of authentication techniques may be used with embodiments of the present invention. Additionally, authentication may be obtained at initiation of the conversation or at a prior point-in-time (e.g., power-on of the device) and/or during the conversation. Further, third-party Service Provider(s) (third-party SP) 410, 412 can obtain and/or add contextual information exchanged among devices of the first VoIP client 406 and second VoIP client 408, Provider 1 402, and Provider 2 404.

In one embodiment, any of Provider 1 402, Provider 2 404, and third-party SP 410, 412 may add, modify, and/or delete contextual information before forwarding the contextual information to the next VoIP device(s), including other service providers.

In response to a request to initiate a conversation channel, the second VoIP client 408 may accept the request for establishing a conversation channel or reject the request via Provider 2 404. For example, the client 406 may accept the request upon identification of the calling client based on the received authentication information. In addition, the second client 408 may provide authentication information to the first client 406. When a conversation channel has been established, the devices of the first VoIP client 406 and the second VoIP client 408 start communicating with each other by exchanging data packets as discussed above. In one embodiment, contextual and/or conversation data packets may be forwarded to third-party SPs 410, 412 from Provider 1 402, Provider 2 404, or from either VoIP client 406, 408. Further, the forwarded contextual and/or conversation data packets may be exchanged among various third-party SPs 410, 412.

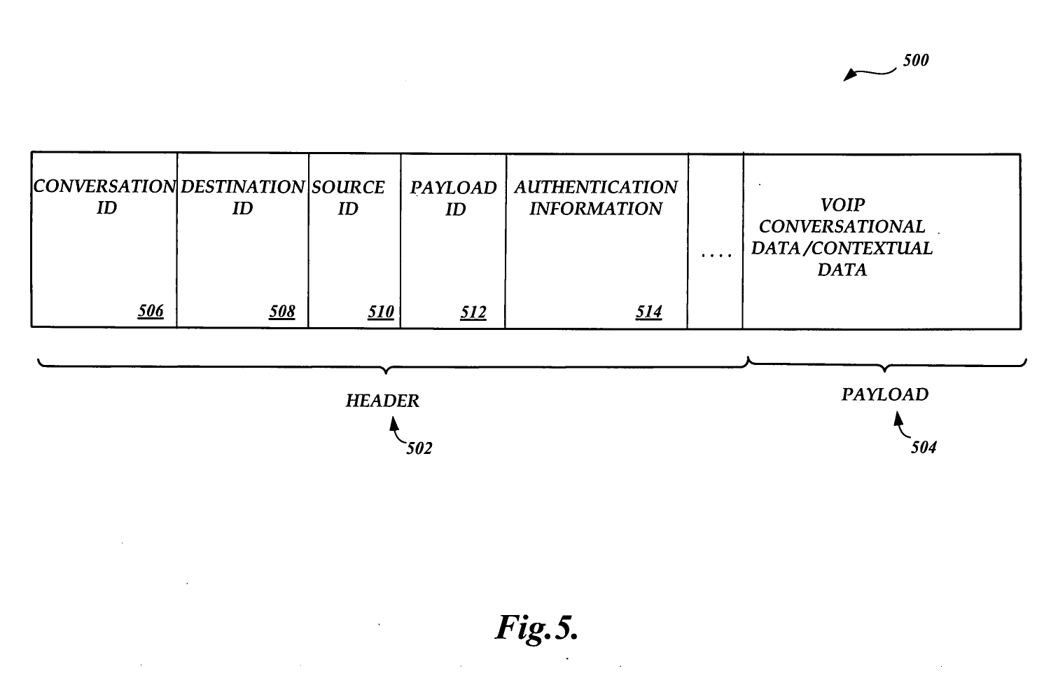

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include a conversation ID 506 for identifying a conversation (e.g., call), a Destination ID 508 such as a unique VoIP identifier of the client being called, a Source ID 510 (unique VoIP identifier of the calling client or device identifier), a Payload ID 512 for identifying type of payload (e.g., conversation or contextual), an individual ID (not shown) for identifying the individual for which the conversation data is related, authentication information 514 for providing authentication of clients, and the like. In an alternative embodiment, the header 502 may contain information regarding Internet protocol versions and payload length, among others. The payload 504 may include conversational or contextual data relating to an identified conversation. As will be appreciated by one of ordinary skill in the art, additional headers may be used for upper layer headers, such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context), and the like. More specifically, the contextual information may include client preference, client rules, client authentication, client's location (e.g., user location, device location, etc.), biometrics information, the client's confidential information, VoIP device's functionality, VoIP service providers information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify, and/or delete VoIP client's contextual data before forwarding the contextual information. For example, if client authentication is being performed by a third-party service provider, it may receive authentication information, confirm the authenticity, replace the authentication information with an authentication confirmation, and forward the contextual information to a receiving client.

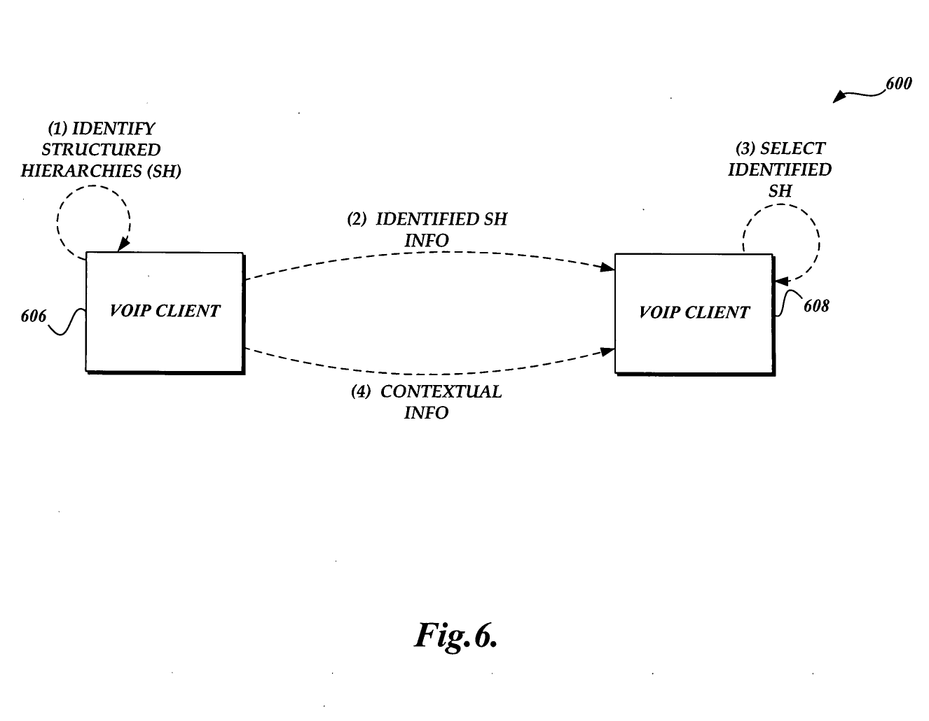

With reference to FIG. 6, a block diagram 600 illustrating interactions between two VoIP clients for transferring contextual information in accordance with an embodiment of the present invention is shown. As with FIGS. 4A and 4B, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information about which structured hierarchy is used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated, thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

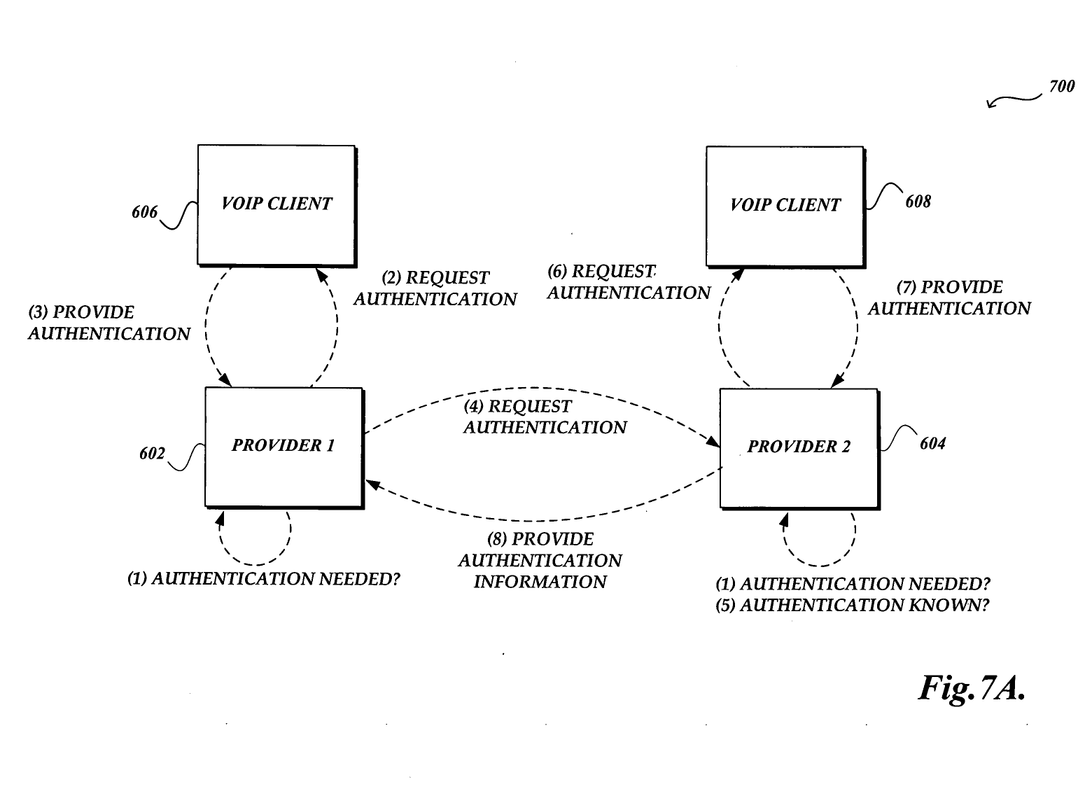

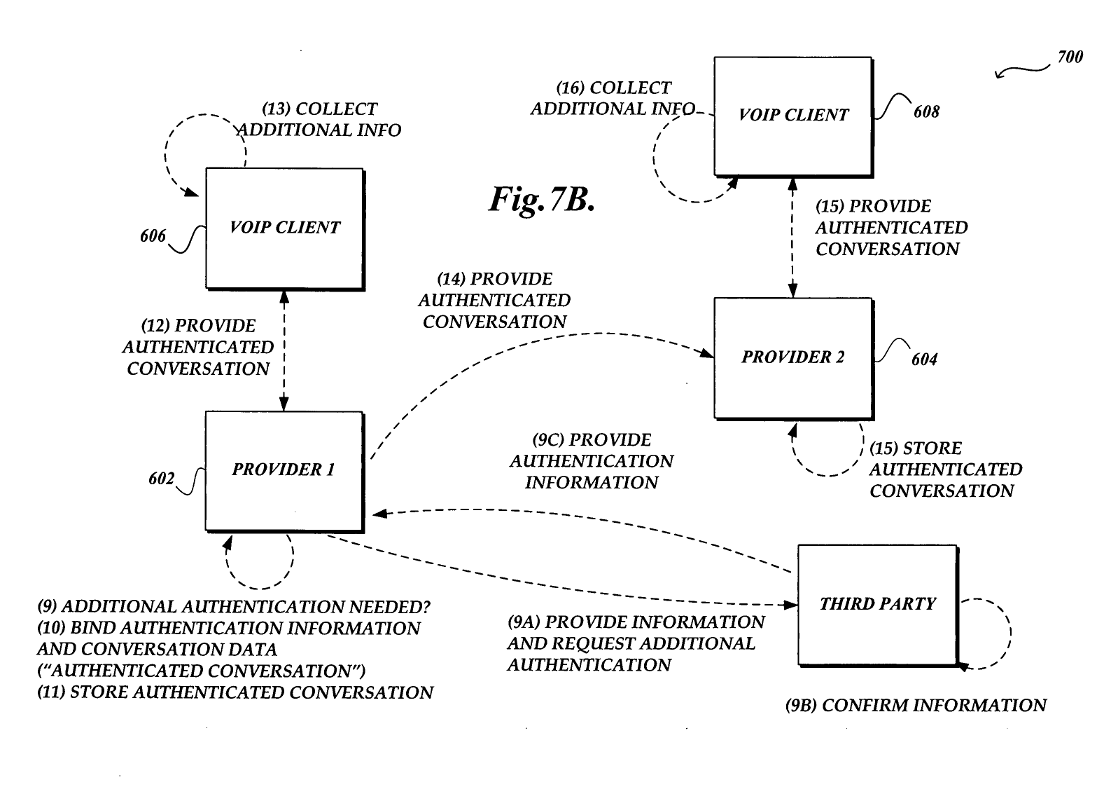

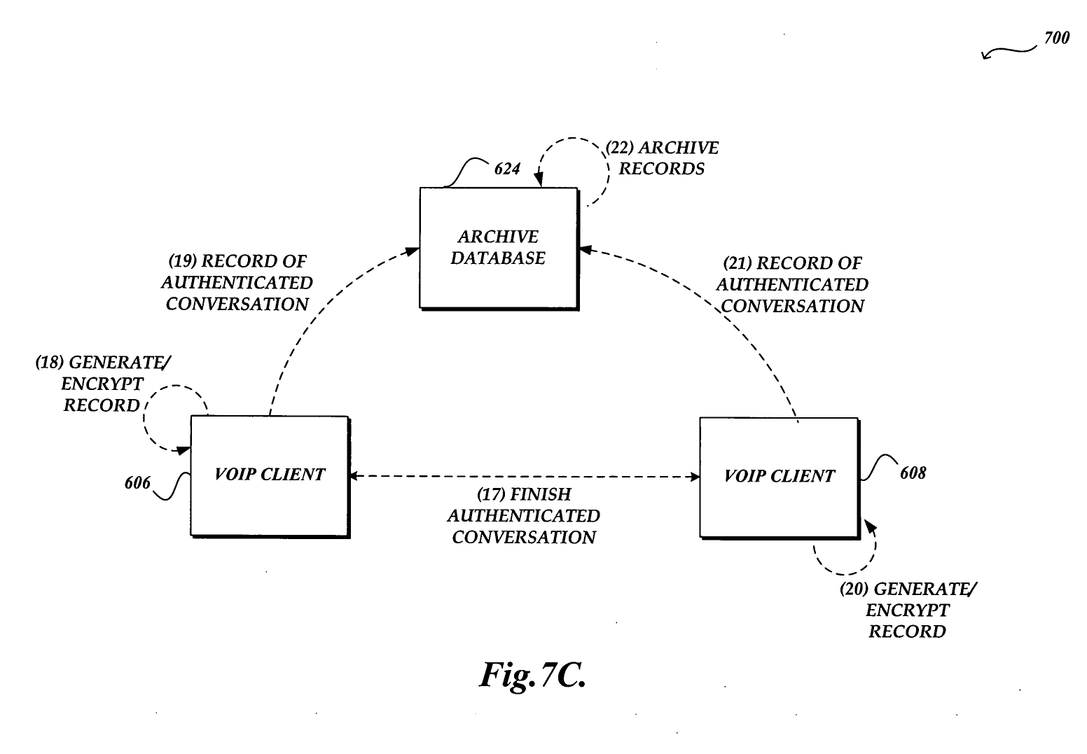

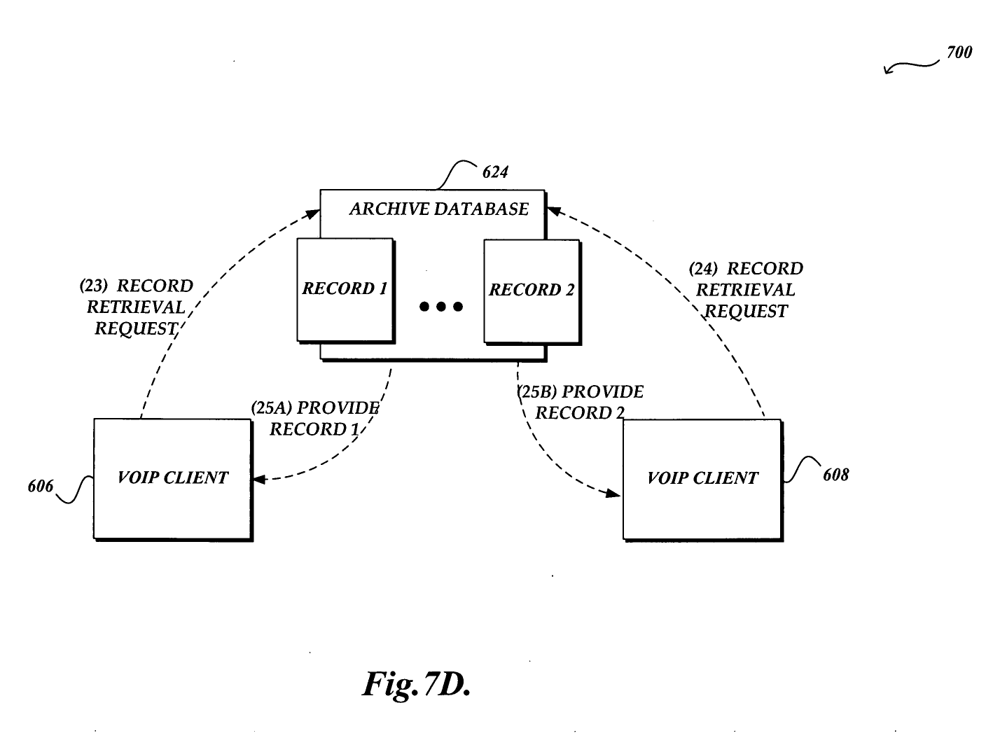

FIGS. 7A-7D are block diagrams 700 illustrating interactions among VoIP entities in the VoIP environment utilizing authentication in accordance with an aspect of the present invention. In one embodiment, the VoIP entities may include VoIP clients, VoIP service providers for the clients, third-party service providers, and the like. As will be appreciated by one of ordinary skill in the relevant art, any suitable entities may be included in the IP telephone environment.

With reference to FIG. 7A, in one embodiment, VoIP Client 606 may already have an existing communication channel with VoIP Client 608. While this example utilizes two VoIP service providers and two VoIP clients (and an optional third-party service provider), any number and combination of VoIP clients and/or service providers may be used with embodiments of the present invention.

During the conversation, any one of the entities may be checking to determine if a conversation archiving is requested. In one embodiment, parties may request a conversation archiving during the conversation in order to record a portion of the conversation or the entire conversation. For example, two parties desire to record their conversation to make a binding oral agreement that can be validated through digital signatures. One of the parties requests a certain portion of a conversation communicated over a VoIP communication channel. The portion of conversation corresponding to the oral agreement may be recorded and necessary digital signatures and identities of the parties may be received and validated. Upon validation of the digital signatures and the identities of the parties, the recoded portion of conversation and the digital signature are bound and then stored in a database. In another embodiment, one of the entities may determine that a conversation archiving is required (or necessary) based on, for example, the conversation, the contextual information exchanged before the conversation, input from one of the contact points in response to an action from an automated system, etc. For example, if during a conversation with an automated system, one of the clients selects a recoding option from a menu provided by the automated system, a service provider may detect this activity and trigger a request for a conversation archiving. While the automated system is recording the conversation, the service provider may generate an authenticated conversation for the client that corresponds to the recorded conversation in the automated system. In this example, the client may have its own record of the conversation against the conversation recorded in the automated system.

For another example, a doctor may transmit an oral order for prescription drugs to a pharmacist. A service provider for the doctor may determine whether the activity of the doctor requires recording of the conversation. Upon determining the activity of the doctor requires recording of the conversation, the service provider starts a conversation archiving. In some instances, the doctor may have a set of rules to trigger a conversation archiving when he/she makes a call to a pharmacist. Subsequently, the doctor and the pharmacist are authenticated for the conversation (oral prescription). During a conversation, the service provider may determine whether additional authentication for the conversation archiving is needed.

In the example illustrated in FIG. 7A, we will discuss the example in which Provider 1 602 determines that authentication is needed. Upon determining that authentication is needed, Provider 1 602 requests authentication information from the VoIP Client 606. The VoIP Client 606, upon receiving such request, generates authentication information for the contact point (e.g., individual user, Interactive Voice Response System (IVRS), etc.) using the VoIP Client 606 devices. For example, an individual user of the VoIP Client 606 may be authenticated using any type of authentication technique including, but not limited to, biometrics, passwords, public/private keys, digital signatures, etc. Authentication information may be provided in any form that is verifiable and that identifies the individual user(s). Some authentication may be done on a device of the VoIP Client 606, at the service provider, and/or a third-party authentication server (online/offline). For example, if the VoIP client device is only capable of obtaining authentication via voice recognition but the authentication information that is to be exchanged as part of the conversation is a digital signature, the device of VoIP Client 606 may authenticate the user through voice recognition, obtain a digital signature associated with the voice from another device of VoIP Client 606, and provide the digital signature as the authentication information.

The VoIP Client 606 may have previously obtained authentication of the user(s) (e.g., credentials, certificates obtained from a third-party authentication server, etc.) and previously generated authentication information, and may provide such authentication information in response. Alternatively, or in addition thereto, the VoIP Client 606 may, in response to the authentication request, obtain authentication of the user(s) and generate authentication information. Upon generation of authentication information, the VoIP Client 606 provides that information to Provider 1 602.

In addition to requesting authentication information from VoIP Client 606, Provider 1 602 sends a request to VoIP Client 608, via Provider 2 604. Provider 2 604, upon receipt of the request may automatically forward the request to the VoIP Client 608 or may determine if it already maintains the necessary authentication information for Client 608. In addition, if Provider 2 604 periodically issues authentication requests, receipt of an authentication request may restart the time period before Provider 2 604 issues an authentication request.

Assuming Provider 2 604 does not have the necessary authentication information for Client 608, or if the authentication information is not current, Provider 2 604 forwards the request to Client 608. Client 608, similar to Client 606, determines if it already has authentication information for the user(s) and may provide that information in response. Alternatively, or in addition thereto, the VoIP Client 608 may, in response to the authentication request, obtain authentication of the user(s) and generate authentication information for the user(s). Upon generation of authentication information, the VoIP Client 608 provides that information to Provider 2 604. Provider 2 604 may store a copy of the received authentication information, along with a timestamp (date/time information) identifying when the information was obtained, and forward the authentication information to Provider 1 602.

Referring now to FIG. 7B, Provider 1 602 may determine that additional authentication is necessary. If the authentication is simply user authentication that periodically occurs, additional authentication may not be necessary. However, if the authentication is for a specific purpose and may be bound to the conversation, additional authentication may be necessary. For example, if a contact point (e.g., an individual) using Client 606 is placing an order to buy a car, additional authentication may be necessary from the bank that will be carrying the loan for the car. Activities where additional authentication may be necessary are numerous and it will be appreciated that any activity that requires additional authentication may be used with embodiments of the present invention. As a general guide, additional authentication using embodiments of the present invention may be used in activities that if typically occurring, would require an individual to appear in person, obtain notarization, obtain a witness signature, or the like.

If it is determined that additional authentication is needed, Provider 1 602 may contact the necessary source for obtaining the additional authentication. For example, the additional authentication may be obtained from one or more third-parties, such as a parent, a bank, or other service provider. Alternatively, the additional authentication may be obtained from one or more of the entities involved in the conversation (e.g., VoIP Client 606, Provider 2 604, etc.). Moreover, as discussed below, one of the devices of the conversation may have already obtained the necessary authentication information (via delegation) that is necessary to confirm and complete the activity. For example, if the activity is the ordering of a prescription drug and the user of VoIP Client 606 is a nurse, or an automated system, the nurse/system may have already obtained, via delegation, the prescribing doctor's authentication information necessary for ordering the prescription drugs.

Returning to the example of FIG. 7A, once the third party is contacted, it confirms the necessary material, such as the context of the conversation and the activity that is being completed and provides the additional authentication that is requested.

Upon receipt of all the necessary authentication information, if the conversation, or a portion thereof, is to be bound with the authentication information, Provider 1 602 may further perform authentication processes based on the authentication information. Provider 1 602 binds the authentication information with the conversation to associate the authentication information with the conversation. Binding may be accomplished by encoding the conversation with the authentication information or through other techniques for associating information. The conversation and bound authentication information is referred to herein as an “authenticated conversation.” The authenticated conversation may be used to verify an activity and/or to verify who participated in a conversation or conducted the activity. Returning to the example of purchasing a car, the conversation between the contact point (“Bob”) and the car dealership (“Car Dealer”) wherein: (1) Bob explains that he wants a Blue 2004 BMW 5451 that is in good shape; (2) the Car Dealer states that they have such a car, that it only has 3,000 miles, and that it is available for $50,000; and (3) Bob acknowledges that he will buy the car for $50,000, may be bound with the authentication information of Bob, the Car Dealer, and the loan company that provides the additional authentication that they will carry the loan on the car to create an authenticated conversation. This authenticated conversation may be stored and used at a later point in time to verify the transaction and, if necessary, prove what each party agreed to and/or stated. The authenticated conversation may be provided to each of the entities involved in the transaction for storage and/or may be stored by Provider 1 602.

Referring now to FIG. 7C, in one embodiment, VoIP Client 606 (or VoIP Client 608) may generate a record of the authenticated conversation to store it in a designated database. The record of authenticated conversation may be encrypted before transmission for security reasons. Further, additional information such as VoIP client's information (e.g., individual user's name, a level of authority, whether the individual user can read or overwrite the record, an effective period of the record, date/time information, etc.) may be included into the record. In one embodiment, upon receipt of the authenticated conversation, the device of VoIP Client 606 may temporarily store the authenticated conversation in local memory. The stored authenticated conversation may be transmitted to the designated database at a predetermined time. In another embodiment, the device of VoIP Client 606 may merely forward the authenticated conversation to the designated database upon receipt of the authenticated conversation, which will subsequently generate and archive a record of the authenticated conversation. In one embodiment, the designated database may be a centralized archive database 624 that is configured to maintain authenticated conversations for various VoIP clients. In this embodiment, each client may be allowed to archive/retrieve records of authenticated conversations to/from the designated database 624 that are associated with the client.

Referring to FIG. 7D, the centralized database 624 may store a record of the authenticated conversation for VoIP Client 606 (Record 1) and a record of the authenticated conversation for VoIP Client 606 (Record 2). In one embodiment, even if Record 1 and Record 2 were created for the same authenticated conversation, Record 1 and Record 2 may be maintained separately since Record 1 and Record 2 were created by different entities. For example, only VoIP Client 606 or a party having a delegation from VoIP Client 606 can access Record 1 while only VoIP Client 608 or a party having a delegation from VoIP Client 608 can access Record 2. In an alternative embodiment, VoIP Client 606 and VoIP Client 608 may share one record for the conversation in the centralized database 624.

In an illustrative embodiment, a retrieved record of a conversation can be modified by an entity with proper authentications and permissions from relevant parties of the authenticated conversation. For example, when the authenticated conversation was generated, the contact point (e.g., an individual user, etc.) of VoIP Client 606 can not provide certain authentication information due to unavailability of some necessary information. In this example, VoIP Client 608 and VoIP Client 606 can agree that the particular authentication information will be provided later when it is available. Some time after the conversation, VoIP Client 606 finally obtains the necessary information and contacts VoIP Client 608. After the particular authentication information is validated, the particular authentication information will be incorporated into the authenticated conversation. In one embodiment, the authenticated conversation may be updated with the new information as long as the activity (updating) is properly authenticated. Generally, a new record of the authenticated conversation will be created with the updated authenticated conversation and a timestamp. Other contact points may be notified of the update.

Further, in one embodiment, the designated database may be a local archive database for the VoIP Client 606. For example, the local archive database may store and manage the authenticated conversations associated with any contact point of VoIP Client 606. In another embodiment, the service provider of VoIP clients may also provide services to archive authenticated conversations. In this embodiment, the service provider may include a database or may be communicatively coupled to a remote database.

In exchanging the requests, the authentication information, and the authenticated conversation, the data packets carrying that information may be defined, as described above, according to structured hierarchies. Further, the information regarding the identified structured hierarchies may be transmitted. The information regarding the identified structured hierarchies may include the information about which structured hierarchies carry the authentication information (part of the contextual information), how to identify the structured hierarchies, and the like. Subsequently, the contextual information corresponding to authentication information may be represented in accordance with the identified structured hierarchies and transmitted.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known as a cross-platform, software and hardware independent tool for transmitting information. Further, XML maintains its data as a hierarchically structured tree of nodes, each node comprising a tag that may contain descriptive attributes. XML is also well known for its ability to allow extendable (i.e., vendor customizable) patterns that may be dictated by the underlying data being described without losing interoperability. Typically, an XML namespace URI is provided to uniquely identify a namespace. In some instances, the namespace may be used as a pointer to a centralized location containing default information (e.g., XML Schema) about the document type the XML is describing.

In an illustrative embodiment, VoIP Client 606 may identify an XML namespace for contextual information. When multiple contexts are aggregated, appropriate XML namespaces can be declared as an attribute at the corresponding tags. It is to be understood that XML namespaces, attributes, and classes illustrated herein are provided merely as an example of structured hierarchies used in conjunction with various embodiments of the present invention. After VoIP Client 608 receives the XML namespace information, VoIP Client 606 transmits a set of contextual data packets defined in accordance with the identified XML namespace to VoIP Client 608. When a namespace is present at a tag, its child elements share the same namespace pursuant to the XML scope rule defined by XML 1.0 specification. As such, VoIP Client 608 and VoIP Client 606 can transmit contextual information without including prefixes in all the child elements, thereby reducing the amount of data packets transmitted for the contextual information.

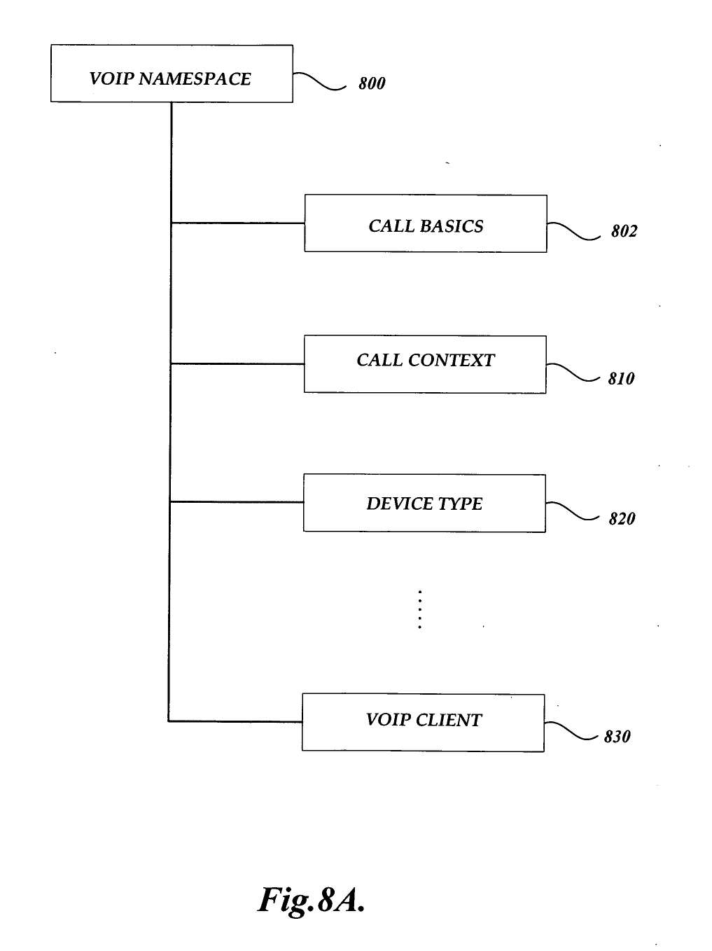

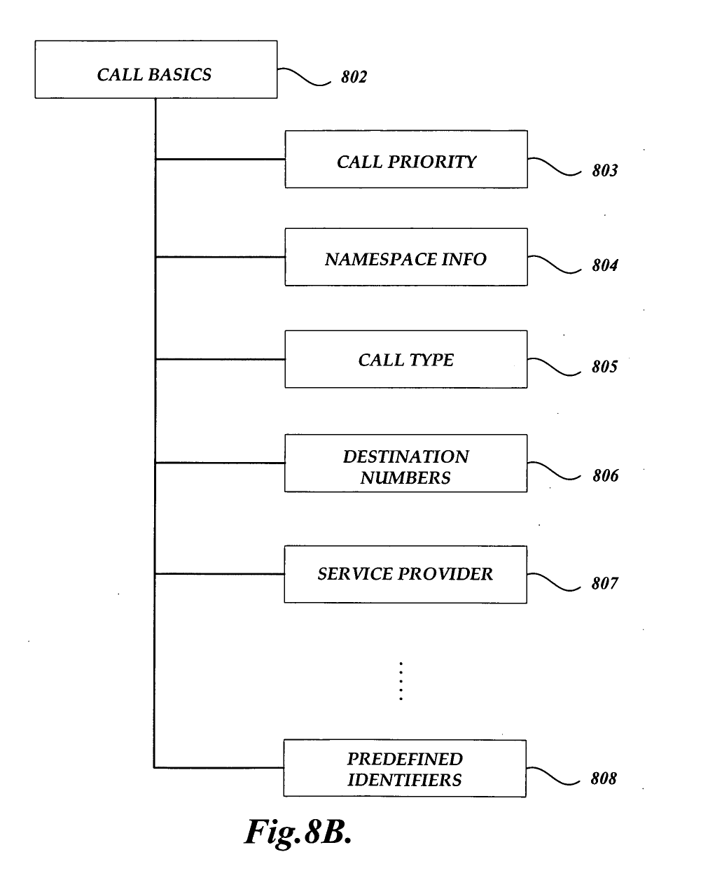

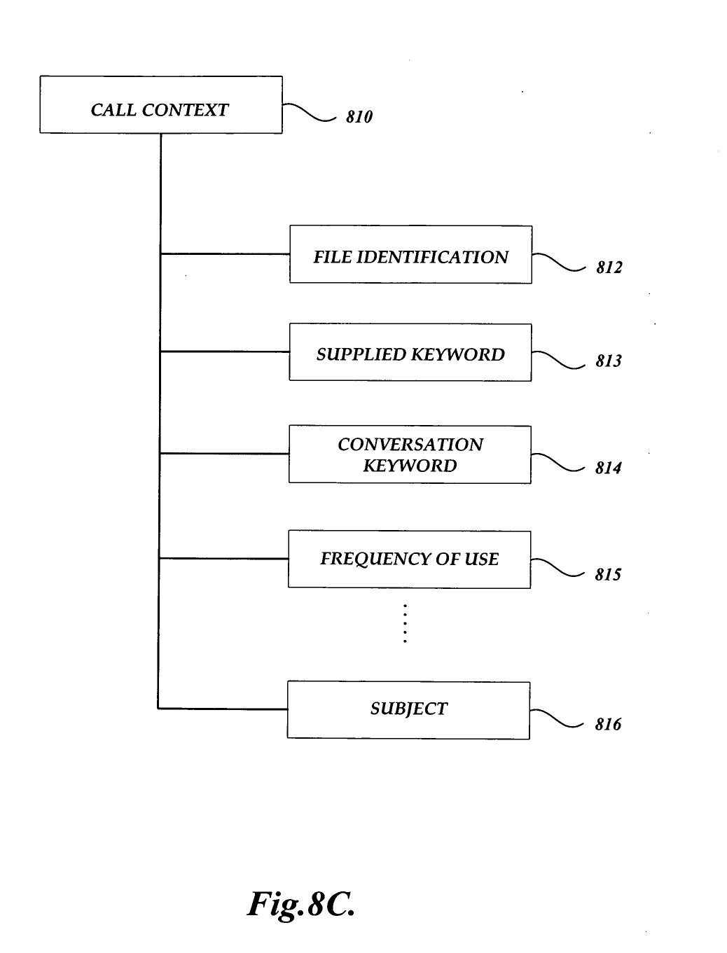

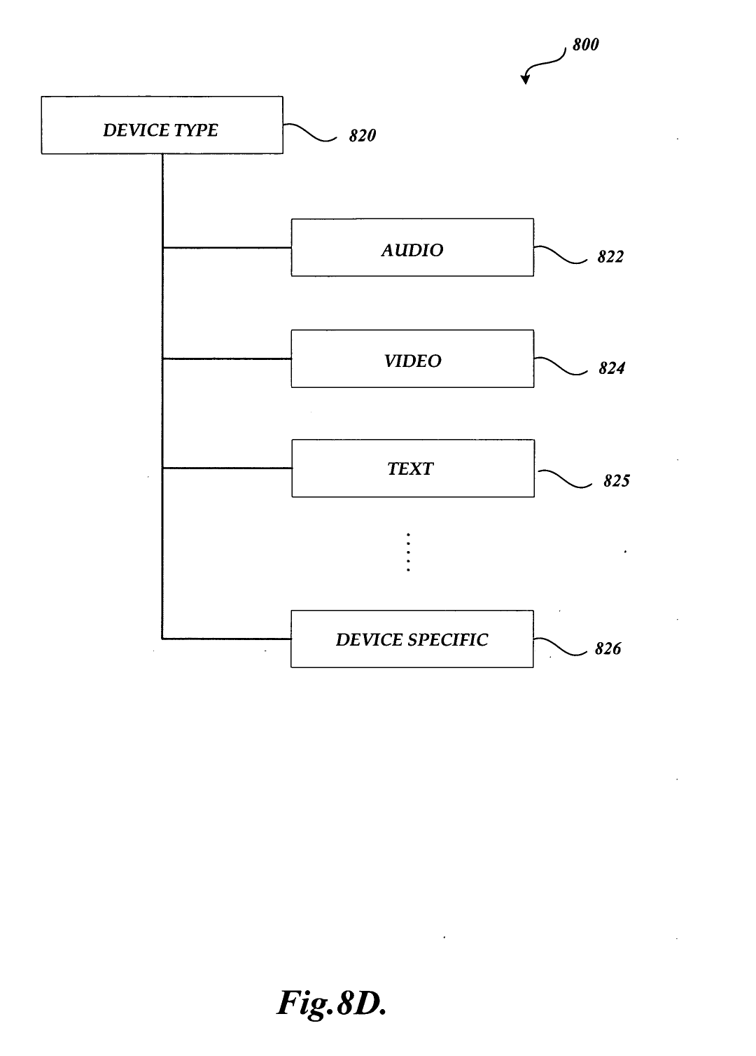

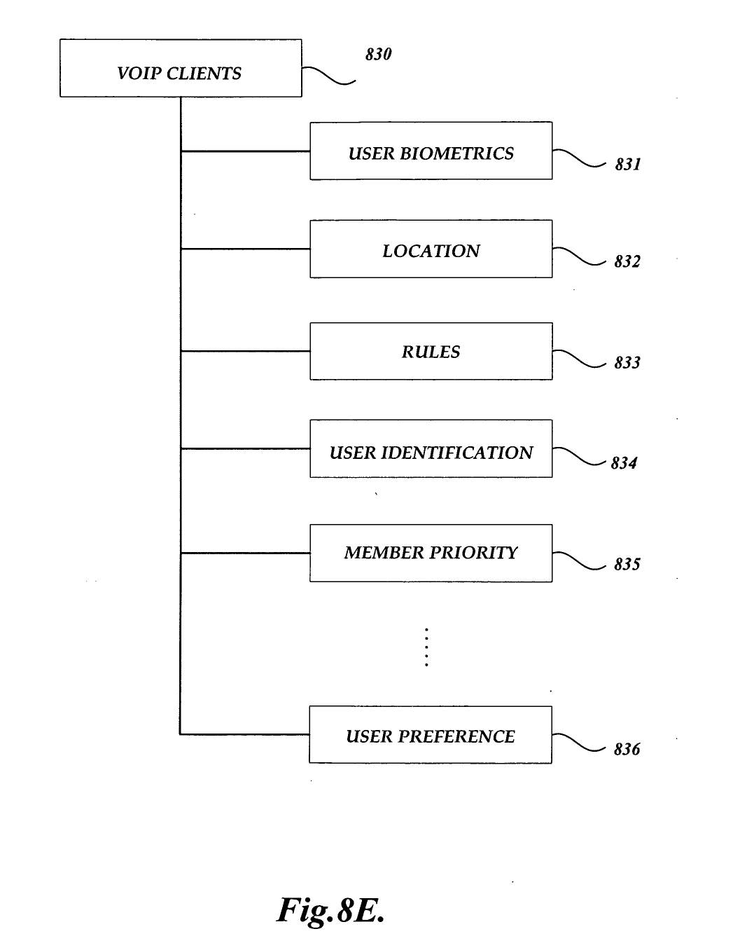

With reference to FIGS. 8A-8E, block diagrams 800 illustrative of various classes and attributes of structured hierarchies corresponding to VoIP contextual information are shown. As mentioned above, structured hierarchies are predefined organizational structures for arranging contextual information to be exchanged between two or more VoIP devices. Structured hierarchies can be defined, updated, and/or modified by redefining various classes and attributes. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a Call Basics Class 802, a Call Contexts Class 810, a Device Type Class 820, a VoIP Client Class 830 and the like.

With reference to FIG. 8B, a block diagram of VoIP Namespace 800 illustrating subclasses of a Call Basics Class 802 is shown. In an illustrative embodiment, a Call Basics Class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's client ID number), destination numbers (e.g., callees' client ID numbers or telephone numbers), call connection time, VoIP service provider related information, and/or ISP related information such as IP address, MAC address, namespace information, and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah”, “oops”, “wow”, etc.) and facial expressions in graphical symbols. In one embodiment, a Call Basics Class 802 may be defined as a subtree structure of a VoIP Namespace 800, which includes nodes such as call priority 803, namespace information 804, call type 805, destination numbers 806, service provider 807, predefined identifiers 808, and the like.

With reference to FIG. 8C, a block diagram of VoIP Namespace 800 illustrating subclasses of a Call Contexts Class 810 is shown. In one embodiment, a subset of VoIP contextual information relating to conversation context may correspond to the Call Contexts Class 810. The contextual information relating to conversation context may include information such as keywords supplied from a client, a service provider, a network, etc. The contextual information relating to conversation context may also include identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 810 may be defined as a subtree structure of a VoIP Namespace 800, which includes nodes corresponding to file identification 812, supplied keyword 813, conversation keyword 814, frequency of use 815, subject of the conversation 816, and the like.

With reference to FIG. 8D, a block diagram of VoIP Namespace 800 illustrating subclasses of a Device Type Class 820 is depicted. In one embodiment, a Device Type Class 820 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, and the like. The subset of the VoIP contextual information relating to the VoIP client device may include video related information which may be needed to process video data generated by the VoIP client device. The video related information may include resolution, refresh, type and size of the video data, graphic card information, and the like. The contextual information relating to VoIP client devices may further include other device specific information such as a type of the computer system, processor information, network bandwidth, wireless/wired connection, portability of the computer system, processing settings of the computer system, and the like. In an illustrative embodiment, a Device Type Class 820 may be defined as a subtree structure of a VoIP Namespace 800, which includes nodes corresponding to Audio 822, Video 824, Text 825, Device Specific 826 and the like.

With reference to FIG. 8E, a block diagram of VoIP Namespace 800 illustrating subclasses of a VoIP Client Class 830 is depicted. In accordance with an illustrative embodiment, a VoIP Client Class 830 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, a service provider, a network, etc., user preferences, digital rights management (DRM), a member rank of an individual user in an organization, priority associated with the member rank, and the like. The priority associated with the member rank may be used to assign priority to the client for a conference call. In one embodiment, a VoIP Client Class 830 may be defined as a subtree structure of a VoIP Namespace 800, which includes nodes corresponding to user biometrics 831, location 832, rules 833, user identification 834, member priority 835, client preference 836, and the like.

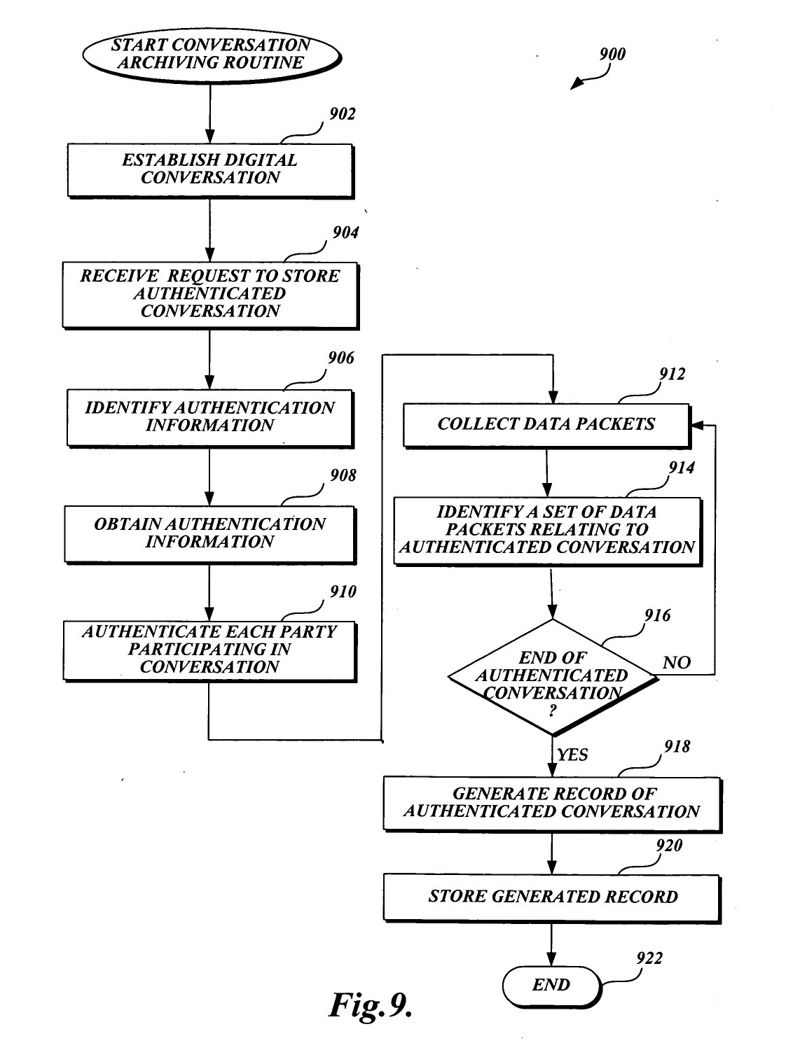

FIG. 9 is a flow diagram of a conversation archiving routine 900 for recording a conversation authenticating a contact point (e.g., an individual, company, etc.) participating in a digital voice conversation in accordance with an embodiment of the present invention. The conversation archiving routine 900 begins at block 902 in which a digital voice conversation between two or more VoIP clients is established. At some point during establishment of a digital voice conversation, or at any time thereafter, a request (an archive request) to store at least a portion of the digital voice conversation may be received by one or more of the VoIP client devices, as illustrated by block 904. As discussed above, an archive request may be automatically generated based on previously obtained contextual information that includes a set of rules indicating the digital voice conversation with a certain VoIP client is to be recorded. For example, a hospital may have specified a set of rules that when a doctor or a nurse makes a call to pharmacists to authorize prescriptions, an authenticated conversation will be automatically recorded and archived. In this example, the predefined set of rules may be transmitted from a device of the contact points (e.g., a doctor or a nurse) involved in the digital voice conversation, as part of contextual information.

Alternatively, an archive request may be received from active input from one of the contact points involved in the digital voice conversation or from a third party monitoring or involved in the digital voice conversation. For example, the client may use a device that is equipped with a button for recording the digital voice conversation. Similarly, a graphic user interface (GUI) may be provided to the contact points with menu options, allowing the contact points to choose one option to start recording the digital voice conversation.

At block 906, upon receipt of the archive request, authentication information necessary to satisfy the archive request is identified. For example, if the authentication is simply identity verification of the contact points, voice recognition may be used for authenticating the contact points. However, if the digital voice conversation is to confirm a transaction, a contact point's age, or some other item of information in which the authentication must be established to a higher degree of certainty, more than one authentication technique may be used. For example, voice authentication in combination with a digital signature may be used to further confirm authentication for the contact points. Upon identification of the authentication information at block 906, at block 908, the identified authentication information may be received as part of contextual information. For example, each contact point has pre-approved that a part of a digital voice conversation can be recorded and stored in a particular database. The pre-approval information may be included in contextual information and transmitted to a service provider.

At block 910, each contact point engaging in a digital voice conversation may be authenticated for the request in order to archive the authenticated conversation. After each contact point has been authenticated, at block 912, a set of data packets is collected. The set of data packets may include voice data packets, media data packet, and/or contextual data packets that can be relevant to the authenticated conversation. At block 914, a set of data packets relating to the authenticated conversation may be identified. At decision block 916, it is determined as to whether the authenticated conversation is ended. For example, each contact point can indicate the ending of the authenticated conversation by various inputs (contextual information) from the devices, voice commands, or the like. Even after the end of the authenticated conversation, the contact points can continue exchanging the digital voice conversation. If it is determined at decision block 916 that the authenticated conversation is not ended, the routine 900 proceeds to block 912 where the data packets are collected. The routine 900 repeats the above mentioned steps until the authenticated conversation has ended.

If it is determined at decision block 916 that the authenticated conversation has ended, at block 918, at least one record of the authenticated conversation may be generated. As described above, a record of the authenticated conversation may bind the identified data packets (i.e., voice/media part of conversation, contextual information, etc.) with the authentication of each party. Returning to the example of purchasing a car described in FIG. 7A, the loan company may provide a fax copy of documents relating to the car loan that may explain terms and conditions of the loan. In this example, contextual information including the fax copy will be part of the authenticated conversation. This authenticated conversation may be stored and used later to verify the transaction and, if necessary, prove what each party agreed to and/or stated. In the example of the car purchase, the authenticated conversation may be used to prove that Bob agreed with the Car Dealer to purchase a Blue 2004 BMW 5451 that has 3,000 miles, for $50,000, of which 80 percent is loaned from the loan company.

In one embodiment, the authenticated conversation may be provided to each of the entities involved in the transaction for storage and/or may be stored by the service providers of the clients. Alternatively, several records of the authenticated conversation may be generated with different authentication information associated with the digital voice conversation. For the purpose of discussion, assume that during the conversation several levels of authentications have been performed among Bob, his wife, the loan company's loan officer, and the Car Dealer. Bob may have communicated with his wife, the loan company's loan officer, and the car dealer with different authentications. In some instances, Bob may desire to keep separate records for a car purchase agreement, a loan agreement, his wife's approval to purchase a car, etc. In this example, Bob can have several different records that are specifically tied to a certain authentication although all the records are related to one authenticated conversation.

As will be appreciated by one of ordinary skill in the art, the authentication(s) can be obtained from a trusted third party online, or the authentication(s) can be obtained from each party (contact point of VoIP client) utilizing the VoIP client device that received the request at block 902. Further, as discussed above, the authentication of a contact point may be obtained using any typical authentication information including, but not limited to, biometrics, passwords, digital signatures, etc. As will be described in greater detail below, the record may include additional information such as information relating to who has authenticated (e.g., an online third-party authentication, an offline third-party authentication, an on-premises authentication, a peer-to-peer authentication, etc.), with what authentication information (e.g., biometrics, passwords, digital signatures), how (e.g., type of authentication protocol, etc.), or the like. Further, the record may include several digital timestamps, for example, a digital timestamp of the record, a digital timestamp of the authenticated conversation, etc.

Once at least one record of the authenticated conversation is generated at block 918, at block 920 the generated record of the authenticated conversation may be stored. The record of the authenticated conversation may be temporarily stored in local storage of the devices of each contact point. The record may be sent to the designated database for archiving at a predetermined time after the digital voice conversation. In this manner, the bandwidth of the devices of clients may be efficiently utilized for the rest of the conversation. In one embodiment, the record of the authenticated conversation may be forwarded directly to an archive database (e.g., on-premises archive database, a third-party archive database, etc.). The routine 900 completes at block 922.

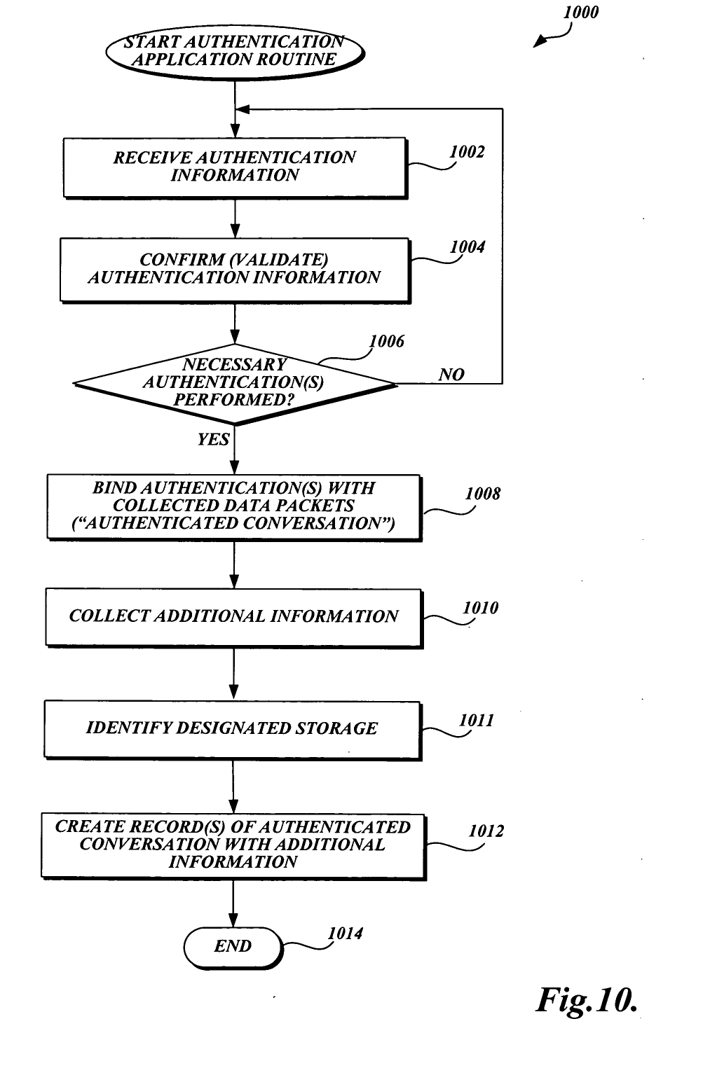

FIG. 10 is an authentication application routine for applying received authentication information to a digital voice conversation in accordance with an embodiment of the present invention. For the purpose of discussion, assume that two VoIP clients, a first client and a second client, are communicating over an established VoIP channel. Each device of the first and the second clients is suitable for collecting and storing an authenticated conversation. The first client has issued a request to archive a digital voice conversation or a portion thereof. Before starting the archiving process, the identity of parties (individual users for the first client and the second client) may be authenticated for the request. After the initial authentication of the parties, one or more additional authentications may be performed over the course of the conversation. For example, the initial authentication may expire after a predetermined time period, which requires a new authentication for each party involved in the digital voice conversation.

At block 1002, the authentication application routine 1000 receives authentication information from one or more VoIP entities involved for providing additional authentication on a digital voice conversation. At block 1004, the received authentication information is confirmed for a proper authentication. For example, if the authentication is periodically performed to verify identity of the parties who are currently communicating over the communication channel, it may be confirmed that the received authentication information matches the previously confirmed authentication information. At decision block 1006, a determination is made as to whether all of the necessary authentication information for the digital voice conversation has been received and confirmed. If it is determined at decision block 1006 that all of the necessary authentication information for the digital voice conversation has not been received or confirmed, the routine 1000 returns to block 1002 and receives the remaining necessary authentication information that is needed to be confirmed. If it is determined at decision block 1006 that all of the necessary authentication information for the digital voice conversation has been received or confirmed, at block 1008 the authentication(s) (i.e., the confirmed/validated authentication information) is bound with the conversation data packets to generate an authenticated conversation.

As mentioned above, the authentication information may be confirmed via a third-party authentication server. For example, a service provider may request a third-party authentication server to authenticate the parties involved in a digital voice conversation. As will be understood by one of ordinary skill in the art, a certain authentication protocol will be utilized for authentication. For the purpose of discussion, assume that a challenge-response authentication protocol is utilized by the service provider and the parties. The service provider may obtain a challenge for each party from the third-party authentication server and forward the response received from each party to the third-party authentication server. Subsequently, the third-party authentication server may verify the response against the challenge and subsequently send the result of the verification. If it is determined that the response corresponds to the challenge, the third-party authentication server will send a confirmation of authentication. Otherwise, the third-party authentication server will send a notification of authentication failure. It is to be noted that the authentication can be done via an online third-party authentication server, via an exchange of credentials that were obtained from an offline third-party authentication server, or the like.

In an illustrative embodiment, the binding of authentication(s) with conversation data packets may include binding the authentication(s) with the data packets for the entire conversation or the data packets only for a portion of that conversation. It is contemplated that during a conversation, the first client or the second client may activate and/or indicate that a particular segment of the conversation between the first and the second clients is to be captured and authenticated. Such an event may indicate to one or more of the VoIP entities that archiving an authenticated conversation is needed, thereby initiating the archiving routine 900 and the authentication application routine 1000, resulting in the binding and creation of the authenticated conversation.

At block 1010, additional information may be collected in order to generate a record of the authenticated conversation, which has a suitable format to be stored in a database. It is to be understood that a particular database system generally specifies a proper format for its database and further requires some additional information to be included in the record for an efficient and secured database management. For example, timestamp information may be collected and added to the record of the conversation. In an embodiment, the record of the authenticated conversation may be encrypted in a way that has been previously agreed with the database. Further, when the database is maintained by a third party, additional user information may be collected for a security reason. At block 1011, designated storage and/or databases where the authenticated conversation will be archived may be identified. It is contemplated that an authenticated conversation may be archived in several different databases based on purposes of archiving. For example, a conversation between a customer and a call center agent may be recorded in a database which is configured to check the call center agent's error for quality control purposes while the same conversation may be recorded in another database in order to prevent unauthorized ordering of drugs, etc. As such, several records of the same authenticated conversation may be generated. At block 1012, at least one record of the authenticated conversation with the additional information may be generated. The authentication application routine 1000 completes, as illustrated by block 1014.

As with FIGS. 9 and 10, it is to be understood that the embodiments explained in conjunction with the routines 900 and 1000 are provided merely for example purposes. It is contemplated that routines 900 and 1000 can also be performed by any VoIP entities involved in a conversation. It is further contemplated that the authenticated conversation can include voice, multimedia, and/or contextual information exchanged among VoIP entities participating in a conversation.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for storing a part of a digital conversation to a designated database wherein the digital conversation is exchanged over a VoIP communication channel, comprising:
receiving a request to store at least part of the digital conversation;
receiving authentication information to authenticate at least one party participating in the digital conversation;
collecting a set of data packets relating to the at least part of the digital conversation;
generating a record of the at least part of the digital conversation with the authentication information and the collected data packets; and
storing the generated record to the designated database.

2. The method of claim 1, wherein the authentication information is digital signature information.

3. The method of claim 1, wherein the authentication information is user biometric information.

4. The method of claim 1, wherein generating a record includes collecting additional information relating to the part of the digital conversation being stored.

5. The method of claim 4, wherein the additional information is date/time information, information relating to a third-party authentication server, or information relating to the designated database.

6. The method of claim 1 further comprising:
identifying a plurality of necessary authentications related to the part of the digital conversation and obtaining authentication information corresponding to each identified authentication.

7. The method of claim 6, further comprising:
confirming each identified authentication based on the obtained authentication information.

8. The method of claim 7, wherein generating a record includes binding the confirmed authentication and the collected data packets.

9. The method of claim 1, wherein the designated database is maintained by a third-party database server that allows each party to retrieve the stored record.

10. The method of claim 1, wherein the conversation data packets include at least one of voice data packets or media data packets that relate to the conversation.

11. A computer-readable medium having computer-executable components for archiving a conversation over a digital voice communication channel, comprising:
an archiving request component for generating a request to archive an authenticated conversation, wherein the authenticated conversation is a part of the conversation that requires at least one authentication;
an information collection component for collecting authentication information relating to the at least one authentication; and
an authentication application component for applying the collected authentication information to the part of the conversation and for authenticating the part of the conversation to confirm the at least one authentication.

12. The computer-readable medium of claim 11, wherein the request to archive is generated in response to input from at least one contact point involved in the conversation.

13. The computer-readable medium of claim 11, wherein the request to archive is generated based on contextual information relating to the conversation, the contextual information being exchanged before the conversation.

14. The computer-readable medium of claim 11, wherein if it is determined that authentication from a third party is necessary, the authentication application component issues a request to the third party for authentication.

15. The computer-readable medium of claim 14, wherein if the at least a portion of the conversation is authenticated, the authentication application component binds the at least a portion of the conversation with the collected authentication information.

16. The computer-readable medium of claim 15, wherein the at least a portion of the conversation includes contextual information and at least one of voice information or media information.

17. A method for generating and storing an authenticated conversation, comprising:
receiving authentication information from at least one device of clients that are involved in a conversation over a VoIP communication channel;
identifying relevant information from the conversation, the relevant information being contextual information and voice information;
collecting the relevant information from the conversation;
confirming a validity of the authentication information; and
if the authentication information is confirmed, binding the confirmed authentication information with the relevant information to generate an authenticated conversation.

18. The method of claim 17, wherein the relevant information relates to an activity in which contact points of the clients involved in the activity need to be authenticated and associated with the conversation.

19. The method of claim 18, wherein the authenticated conversation is temporarily stored on the at least one device of the clients, the stored authenticated conversation being sent to a centralized archiving repository at a predetermined time.

20. The method of claim 17 further comprising:
obtaining an approval from contact points of the clients to generate the authenticated conversation before binding the confirmed authentication information with the relevant information.
